(19) United States
(12) Patent Application Publication
(10) Pub. No.: US 2018/0305092 A1
(43) Pub. Date: Oct. 25, 2018

(54) SLIDABLY OPENABLE CHILD RESISTANT CONTAINER

(71) Applicant: CSP TECHNOLOGIES, INC., Auburn, AL (US)

(72) Inventor: Franklin Lee Lucas, JR., Opelika, AL (US)

(21) Appl. No.: 15/960,768

(22) Filed: Apr. 24, 2018

Related U.S. Application Data
(60) Provisional application No. 62/489,038, filed on Apr. 24, 2017.

(51) Int. Cl. B65D 50/04; A61J 1/03

(52) U.S. Cl. CPC B65D 50/046; A61J 1/03

(57) ABSTRACT

A child resistant container includes a first component having a first coupling mechanism, and a second component having a second coupling mechanism slidably coupled to the first coupling mechanism. The container is configured to move between a FIRST position and a SECOND position. When the container is in the FIRST position, the first and second components form a compartment configured to contain at least one product. When the container moves from the FIRST position toward the SECOND position, the first component slides relative to the second component, thereby providing an opening into the compartment.

### CROSS-REFERENCE TO RELATED APPLICATION

This application claims priority from and claims the benefit of United States Provisional Patent Application Ser. No. 62/489,038, filed Apr. 24, 2017, and entitled “CHILD RESISTANT CONTAINER WITH SLIDABLE PRODUCT COMPARTMENT”.

### FIELD OF THE INVENTION

The invention relates generally to child resistant containers, and in particular to a child resistant container wherein a first component is configured to slide relative to a second component.

### BACKGROUND

Medication (e.g., without limitation, prescription and non-prescription pills) is often stored in containers. While known containers provide a reliable mechanism to store medication, they suffer from a number of disadvantages. Among those is the fact that many of the containers are not particularly difficult to open. Why this is problematic is that if the containers can be opened too readily, then children might be able to inadvertently open them and gain access to the medication inside. Ingestion of the medication in even small doses by a child not intended to be the recipient of that medication could cause physical harm and even death. As such, there is a need for an improved child resistant container.

### SUMMARY OF THE INVENTION

Accordingly, in one aspect there is provided a child resistant container. The container includes a first component having a first coupling mechanism, and a second component having a second coupling mechanism slidably coupled to the first coupling mechanism. The container is configured to move between a FIRST position and a SECOND position. When the container is in the FIRST position, the first and second components form a compartment configured to contain at least one product. When the container moves from the FIRST position toward the SECOND position, the first component slides relative to the second component, thereby providing an opening into the compartment.

### BRIEF DESCRIPTION OF THE DRAWINGS

Exemplary embodiments of the present invention are shown in the enclosed drawings as follows:

FIG. 1 is an exploded isometric view of a child resistant container, shown with a number of pills on a component, in accordance with one non-limiting embodiment of the disclosed concept;

FIG. 2 is an assembled isometric view of the container of FIG. 1, shown with the container in a FIRST position;

FIG. 3 is another assembled isometric view of the container of FIG. 1, shown with the container having partially moved toward a SECOND position;

FIG. 4 is another assembled isometric view of the container of FIG. 1, shown with the container in the SECOND position, and with a number of pills disposed on a component of the container; and

FIG. 5 shows an exploded isometric view of another container, in accordance with another non-limiting embodiment of the disclosed concept.

### DETAILED DESCRIPTION OF THE PREFERRED EMBODIMENTS

As used herein, the word “unitary” means a component that is created as a single piece or unit. Under this definition, a component that includes pieces that are created separately and then coupled together as an assembled unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one. As employed herein, the statement that two or more parts are “connected” or “coupled” together shall mean that the parts are joined together either directly or joined through one or more intermediate parts.

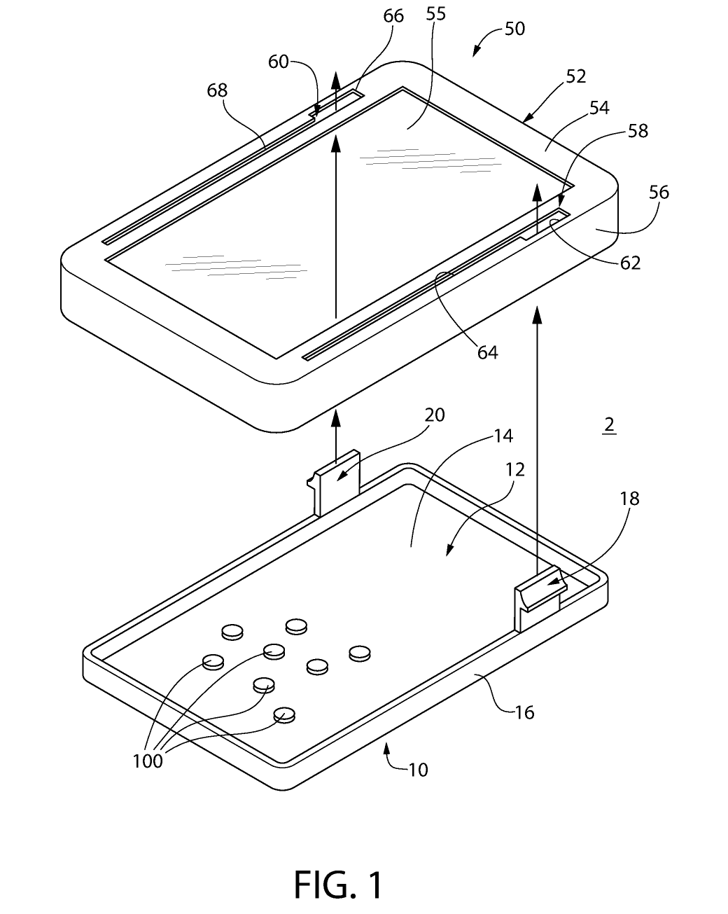

FIG. 1 is an exploded isometric view of a child resistant container 2, in accordance with one non-limiting embodiment of the disclosed concept. As will be discussed in greater detail below, container 2 is configured to contain medicine (e.g., without limitation, pills 100), and is further configured to provide a novel mechanism that minimizes the likelihood that a child will inadvertently open container 2. As shown, container 2 includes a first component 10 and a second component 50 configured to be slidably coupled to first component 10. First component 10 includes a body portion 12 having a floor portion 14 and a peripheral rim 16 extending from and optionally being oriented substantially perpendicular to floor portion 14. Additionally, first component 10 further includes a first coupling mechanism in the form of a number of protrusions 18,20 extending outwardly from body portion 12 (e.g., outwardly from peripheral rim 16 away from floor portion 14). Optionally, the number of protrusions 18,20 are two in number and are disposed directly opposite each other. In one example embodiment, first component 10 is a unitary component made from a single piece of material (e.g., without limitation, an injection molded piece). Furthermore, as will be discussed below, in the illustrative embodiment of FIG. 1, protrusions 18,20 are configured to flex inwardly.

Second component 50 includes a body portion 52 having a ceiling portion 54 and a peripheral rim 56 extending from and being located substantially perpendicular to ceiling portion 54. Furthermore, second component 50 has a second coupling mechanism in the form of a number of slots 58,60 formed in ceiling portion 54. It will be appreciated that slots 58,60 are slidably coupled to protrusions 18,20 of first component 10. Continuing to refer to FIG. 1, slots 58,60 each include a corresponding enlarged portion 62,66 and a corresponding sliding portion 64,68 extending from the enlarged portion 62,66. When protrusions 18,20 are disposed in sliding portions 64,68, protrusions 18,20 are biased toward an exterior of container 2, as will be discussed below.

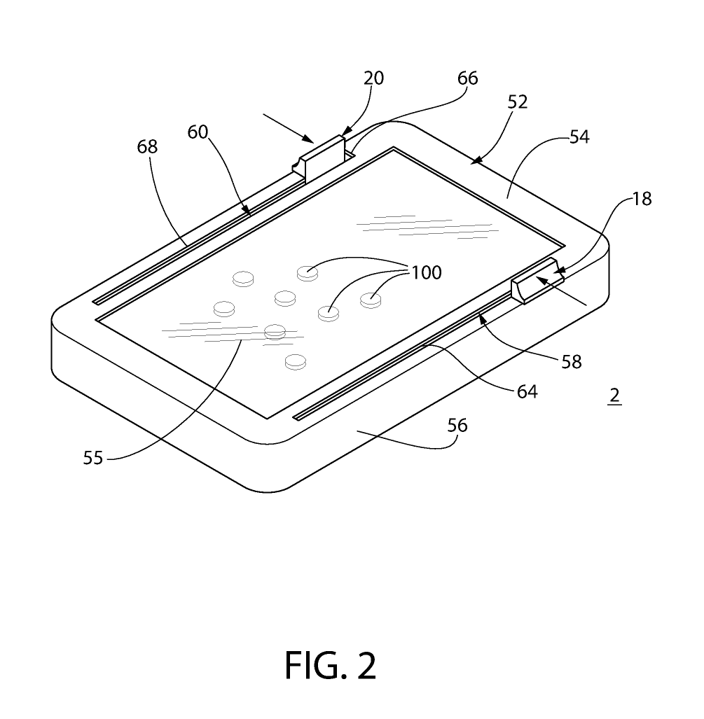

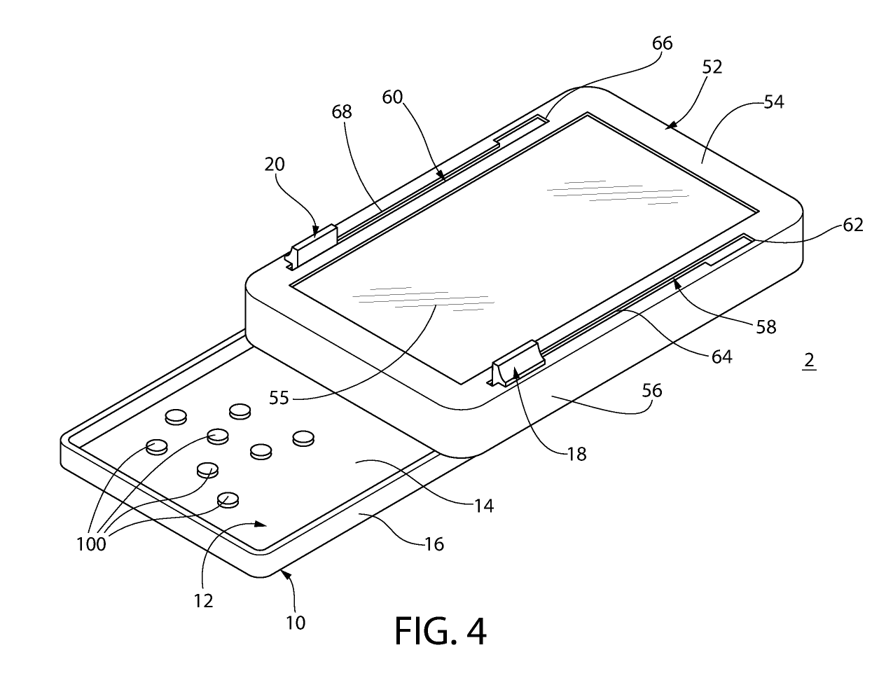

Referring to FIG. 2, in one example embodiment, when container 2 is assembled, each of protrusions 18,20 extends at least partially into a corresponding one of slots 58,60, preferably extending through slots 58,60. In the position depicted in FIG. 2, a FIRST position, protrusions 18,20 are each located at a periphery of enlarged portions 62,66 (see FIG. 1) and are preferably biased away from each other. Accordingly, when container 2 is in the FIRST position, first and second protrusions 18,20 are each located in a corresponding one of first and second enlarged portions 62,66 in order to maintain container 2 in the FIRST position. When container 2 is in this FIRST position, first and second components 10,50 form a compartment configured to contain at least one product (e.g., pills 100). Additionally, in accordance with the disclosed concept, container 2 is configured to move between the FIRST position and a SECOND position (see FIG. 4). Specifically, when container 2 moves from the FIRST position (FIG. 2) toward the SECOND position (FIG. 4), first component 10 slides relative to second component 50, thereby providing an opening into the compartment. Once the container 2 has reached the SECOND position, the container 2 is configured to be unable to any slide further in the direction it had moved to reach the SECOND position. The opening into the compartment (with the container 2 in the SECOND position) may be used to access pills 100.

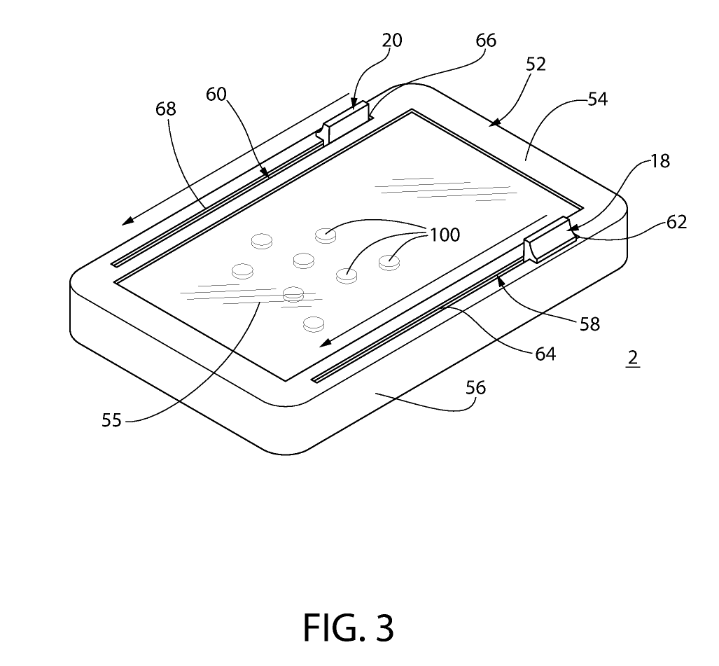

In one example embodiment of the disclosed concept, when container 2 moves from the FIRST position (FIG. 2) toward the SECOND position (FIG. 4), first and second protrusions 18,20 initially move toward each other (e.g., are squeezed toward each other by a patient, such as an adult patient who can contemplate the mechanics of opening container 2), thereby allowing first component 10 to slide relative to second component 50. Compare, for example, FIGS. 2 and 3. Specifically, FIG. 3 shows container 2 with protrusions 18,20 pressed closer to each other than in FIG. 2. As such, from the position in FIG. 3, enlarged portions 62,66 of slots 58,60 no longer obstruct protrusions 18,20. That is, in the position of FIG. 2, enlarged portions 62,66 prevent protrusions 18,20, and thus first component 10, from sliding with respect to second component 50. As such, once they have been pressed inwardly, protrusions 18,20 are free to slide in sliding portions 64,68 of slots 58,60 to allow container 2 to be opened. Thus, when container 2 moves from the FIRST position (FIG. 2) toward the SECOND position (FIG. 4), each of first and second protrusions 18,20 slides in a corresponding one of first and second sliding portions 64,68 away from first and second enlarged portions 62,66.

It will thus be appreciated that container 2 provides a novel child-resistant mechanism to contain medicine (e.g., pills 100), while protecting children who might otherwise gain access to contents of a container. Specifically, adults will readily be able to understand that a simple mechanical motion of squeezing protrusions 18,20 toward each other, and then sliding them away from corresponding enlarged portions 62,66 of slots 58,60 will provide an opening into the compartment and thus access to pills 100 located therein. However, to most young children such a motion is not so simple, a feature which protects them from potentially ingesting the medicine.

Continuing to refer to FIGS. 1-4, second component 50 optionally includes a membrane 55 coupled to ceiling portion 54 of body portion 52, and preferably being located between first and second protrusions 18,20. Membrane 55 is substantially transparent in order to allow viewing into the compartment when container 2 is in the FIRST position (FIG. 2). For example, as shown in FIG. 2, pills 100 located in the compartment of container 2 are visible through membrane 55. Additionally, in one example embodiment, membrane 55 is made from a fluorinated ethylene propylene material. While membrane 55 of container 2 is described and shown herein as being provided on second component 50, it will be appreciated that a suitable alternative first component (not shown) may instead or additionally have a membrane substantially the same as membrane 55 in order to provide visibility into the compartment.

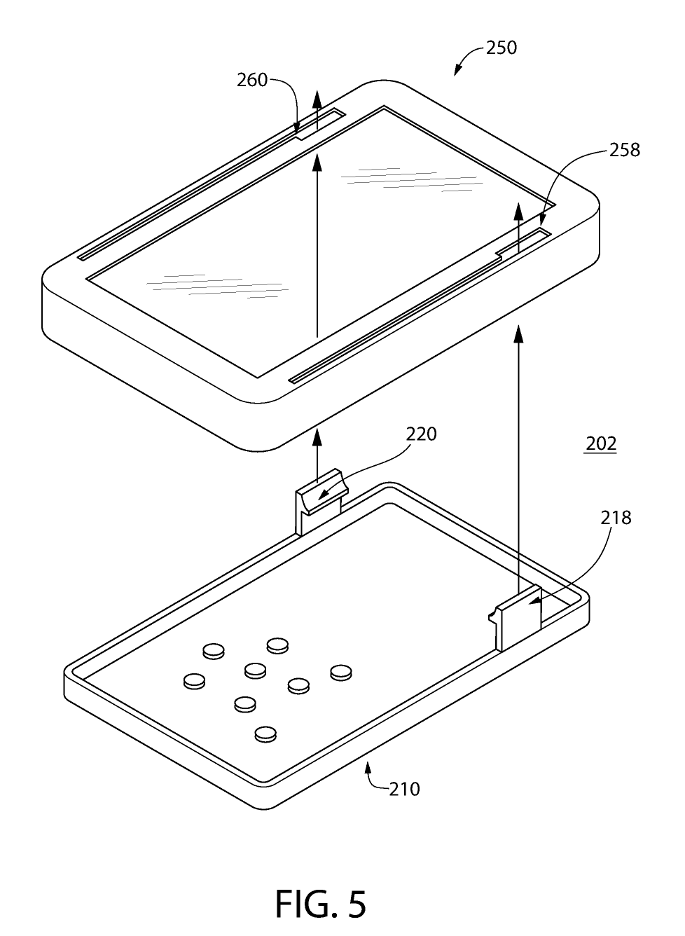

While the disclosed concept has been described in association with protrusions 18,20 of first component 10 moving toward each other to open container 2, it will readily be appreciated that suitable alternative configurations of containers are contemplated by the disclosed concept. For example and without limitation, FIG. 5 shows another container 202 having first and second components 210,250. When container 202 moves from the FIRST position toward the SECOND position, first and second protrusions 218,220 initially move away from each other, thereby allowing first component 210 to slide relative to second component 250. Compare, for example, the geometry of slots 258,260 of second component 250 to the geometry of slots 58,60 of second component 50 (FIG. 1). Specifically, when container 202 in the FIRST position, protrusions 218,220 engage against inner edges of slots 258,260, and upon moving toward the SECOND position, are pressed outwardly toward and/or are engaged against outer edges of slots 258,260. When container 2 (FIGS. 1-4) is in the FIRST position (FIG. 2), by way of contrast, protrusions 18,20 engage against outer edges of slots 58,60. Upon moving toward the SECOND position, protrusions 18,20 are pressed inwardly toward and/or are engaged against inner edges of slots 58,60.

Suitable other containers are contemplated by the disclosed concept. For example and without limitation, in a suitable alternative container (not shown), when the container moves from a FIRST position toward a SECOND position, the first and second protrusions may initially move away from the body portion of the second component, thereby allowing the first component to slide relative to the second component.

The disclosed concepts have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed:

1. A child resistant container comprising:
a first component having a first coupling mechanism; and
a second component having a second coupling mechanism slidably coupled to the first coupling mechanism,
wherein the container is configured to move between a FIRST position and a SECOND position,
wherein, when the container is in the FIRST position, the first and second components form a compartment configured to contain at least one product, and
wherein, when the container moves from the FIRST position toward the SECOND position, the first component slides relative to the second component, thereby providing an opening into the compartment.

2. The container according to claim 1, wherein the first component comprises a body portion; wherein the first coupling mechanism is a number of protrusions extending outwardly from the body portion; wherein the second component comprises a body portion; wherein the second coupling mechanism is a number of slots formed in the body portion of the second component; and wherein each of the number of protrusions is configured to extend at least partially into a corresponding one of the number of slots.

3. The container according to claim 2, wherein the number of slots comprises a first slot and a second slot disposed opposite the first slot; wherein the number of protrusions comprises a first protrusion and a second protrusion disposed opposite the first protrusion; and wherein each of the first protrusion and the second protrusion extends at least partially into a corresponding one of the first slot and the second slot.

4. The container according to claim 3, wherein, when the container moves from the FIRST position toward the SECOND position, the first protrusion and the second protrusion initially move toward each other, thereby allowing the first component to slide relative to the second component.

5. The container according to claim 3, wherein, when the container moves from the FIRST position toward the SECOND position, the first protrusion and the second protrusion initially move away from each other, thereby allowing the first component to slide relative to the second component.

6. The container according to claim 3, wherein, when the container moves from the FIRST position toward the SECOND position, the first protrusion and the second protrusion initially move away from the body portion of the second component, thereby allowing the first component to slide relative to the second component.

7. The container according to claim 3, wherein the first slot comprises a first enlarged portion and a first sliding portion extending from the first enlarged portion; wherein the second slot comprises a second enlarged portion and a second sliding portion extending from the second enlarged portion; and wherein, when the container is in the FIRST position, each of the first protrusion and the second protrusion is disposed in a corresponding one of the first enlarged portion and the second enlarged portion in order to maintain the container in the FIRST position.

8. The container according to claim 7, wherein, when the container moves from the FIRST position toward the SECOND position, each of the first protrusion and the second protrusion slides in a corresponding one of the first sliding portion and the second sliding portion away from the first and second enlarged portions.

9. The container according to claim 1, wherein at least one of the first component and the second component comprises a body portion and a membrane coupled to the body portion; and wherein the membrane is substantially transparent in order to allow viewing into the compartment when the container is in the FIRST position.

10. The container according to claim 9, wherein the membrane is made from a fluorinated ethylene propylene material.
